(19) United States
(12) Patent Application Publication
(10) Pub. No.: US 2008/0016648 A1
(43) Pub. Date: Jan. 24, 2008

(54) FURNITURE HINGE

(75) Inventor: Horst Lautenschlager, Reinheim (DE)

Correspondence Address: CARLSON, GASKEY & OLDS, P.C., 400 WEST MAPLE ROAD, SUITE 350, BIRMINGHAM, MI, 48009, US

(73) Assignee: LIBERTY HARDWARE MFG. CORP., Winston-Salem, NC (US)

(21) Appl. No.: 11/737,164

(22) Filed: Apr. 19, 2007

(30) Foreign Application Priority Data
Jul. 21, 2006 (DE) 102006034306.9

(51) Int. Cl. E05D 7/04

(52) U.S. Cl. 16/238

(57) ABSTRACT

An example furniture door hinge includes a carrier arm having a first arm end and a second arm end, a door rabbet element rotatably fastens to the first arm end, and a fastening plate is disposed on the second arm end. The fastening plate is formed with the carrier arm and has a threaded hole near the carrier arm for receiving a lateral adjustment screw. A mounting plate attaches to the body of a piece of furniture, the second arm end longitudinally and laterally adjustably connects to the mounting plate and the fastening plate longitudinally guided across the mounting plate. The lateral adjustment screw accommodates at least one edge of a longitudinal slot in the mounting plate within a circumferential groove. The longitudinal slot is closed near the carrier arm and enlarged away from the carrier arm to receive the screw head.

The present invention claims the benefit of German Patent Application No. 10 2006 034 306.9, filed Jul. 21, 2006.

### BACKGROUND OF THE INVENTION

This invention relates to a furniture hinge. More particularly, this invention relates to a furniture hinge having a door rabbet element that is rotatably disposed on a carrier arm that is longitudinally and laterally adjustably disposed on a mounting plate attachable to a furniture frame. A fastening plate, which is made in one piece with the carrier arm and which lies against the mounting plate, is carried longitudinally on the mounting plate. The fastening plate exhibits, on the end toward the carrier arm, a lateral adjusting screw in a threaded hole. The screw accommodates the two edges of a longitudinal slot in the mounting plate in a circumferential groove.

Some furniture hinges serve for the pivotable attachment of a furniture door to a piece of furniture. To align the furniture door with the furniture, furniture hinges may be laterally adjustable so that the furniture door can be adjusted in the horizontal direction along a front surface of the furniture. Furniture hinges may be additionally longitudinally adjustable so that the separation between the furniture door and the front surface of the furniture body, for example, a front frame, is adjustable.

Known furniture hinges use a lateral adjustment screw to adjust the separation between the fastening plate and the end of the mounting plate toward the carrier arm. A circumferential groove of the lateral adjustment screw accommodates two edges of a longitudinal slot in the mounting plate. The slot is open in the direction of the carrier arm to permit assembly by inserting the lateral adjustment screw. The lateral adjustment screw rotates within the longitudinal slot of the mounting plate without axial displacement. Since the lateral adjusting screw is accommodated in a threaded hole in the fastening plate, rotation of the screw changes the distance between the fastening plate and the mounting plate.

At another end of the hinge away from the carrier arm, the fastening plate and the mounting plate connect together in such a way that their separation remains unchanged. The two adjacent sections of the fastening plate and the mounting plate are in relatively close proximity. An eccentric element joins these two plates. Moving the eccentric element longitudinally adjusts the fastening plate relative to the mounting plate in a direction transverse to the front surface of the furniture.

The eccentric element may rotatably attach to the mounting plate through a pivot having an eccentric section extending through a cross-slot in the fastening plate. Rotating the eccentric element longitudinally displaces the fastening plate with respect to the mounting plate, which is fixedly attached to the body of the furniture. This displaces the lateral adjustment screw within the longitudinal slot.

A cutout in the longitudinal slot, open in the direction of the carrier arm, facilitates assembly of the fastening plate onto the mounting plate. However, when overloaded, the connection between the fastening plate and the mounting plate in the longitudinal direction of adjustment may fail. For example, if the mounting pin of the eccentric element is pulled out of the mounting plate, the fastening plate can be pulled away from the mounting plate in the longitudinal direction. Overloading a furniture door by a force operating from above, such as when a person pulls down on the furniture door, exerts a horizontal tension force on the upper furniture hinge of the furniture door. If the furniture hinge fails in the manner described above, the furniture door may break loose from the furniture frame in the region of the upper furniture hinge. In many cases loads on the upper furniture hinge extend to the lower furniture hinge. If both hinges fail under load, the furniture door falls from the body of furniture. This can lead not only to serious damage to the piece of furniture, but also to injuries.

It would be desirable to design a furniture hinge that lessens the risk of the door rabbet element separating from the mounting plate under load.

### SUMMARY

An example furniture door hinge includes a carrier arm having a first arm end and a second arm end, a door rabbet element rotatably fastens to the first arm end, and a fastening plate is disposed on the second arm end. The fastening plate is formed with the carrier arm and has a threaded hole near the carrier arm for receiving a lateral adjustment screw. A mounting plate attaches to the body of a piece of furniture, the second arm end longitudinally and laterally adjustably connects to the mounting plate and the fastening plate longitudinally guided across the mounting plate. The lateral adjustment screw accommodates at least one edge of a longitudinal slot in the mounting plate within a circumferential groove. The longitudinal slot is closed near the carrier arm and enlarged away from the carrier arm to receive the screw head.

Another example furniture door hinge includes a longitudinal slot in a mounting plate having a closed end toward a carrier arm and an enlarged end away from the carrier arm. The enlarged end is adapted to accommodate the insertion of the bolt head.

### BRIEF DESCRIPTION OF THE DRAWINGS

The various features and advantages of this disclosure will become apparent to those skilled in the art from the following detailed description. The drawings that accompany the detailed description can be briefly described as follows.

FIG. 1 illustrates a top view of an example furniture hinge.

FIG. 2 illustrates a side sectional view along line 2-2 of FIG. 1

FIG. 3 illustrates a bottom view of the example furniture hinge.

FIG. 4 illustrates a front sectional view along line 4-4 of FIG. 2.

FIG. 5 illustrates a mounting plate of the example furniture hinge

### DETAILED DESCRIPTION

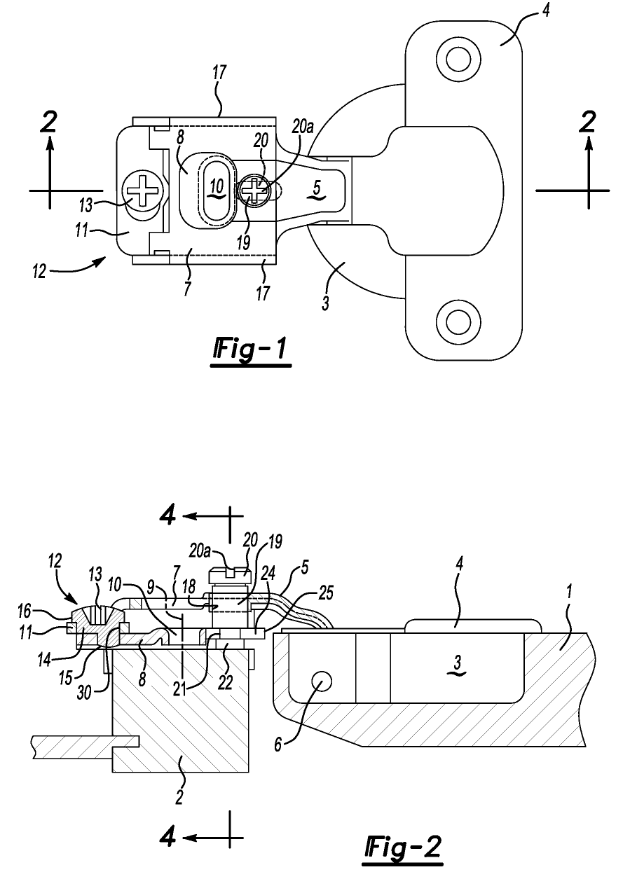

Referring to FIGS. 1 and 2, the example furniture hinge pivotably attaches a furniture door 1 to a furniture frame. For example, the example hinge attaches to a furniture front frame 2 of a piece of furniture of the “face-frame” design.

The furniture hinge includes an insert cup, a type of door rabbet element 3. Screws (not shown) driven through screw-attachment tabs 4 attach the door rabbet element to the furniture door 1. A carrier arm 5 includes on one end toward furniture door 1 a rotatable hinge or linkage consisting of a hinge pin 6. The hinge pin 6 attaches the carrier arm 5 to the door rabbet element 3, which is secured to the furniture door 1. The carrier arm 5 is formed from sheet-metal for example.

A fastening plate 7 is disposed on another end of the carrier arm 5, the end away from the furniture door 1. The carrier arm 5 and the fastening plate 7 are formed in one piece, for example. The fastening plate 7 connects to a mounting plate 8, which is screwed onto front-frame 2.

The mounting plate 8 attaches to the front-frame 2 using a fastening screw 9, which is indicated by a broken line in FIG. 2. The fastening screw 9 extends through an elongated hole 10 that extends perpendicularly across the mounting plate 8 to the longitudinal direction of the mounting plate 8. The elongated hole 10 permits height adjustment when fastening the mounting plate 8 to the front-frame 2.

A cross-step 11 on the fastening plate 7 adjustably connects to the mounting plate 8 with a longitudinal adjustment provision 12. The longitudinal adjustment provision 12 includes an eccentric element 14 having a Philips-head screw head for receiving an adjusting tool. The eccentric element 14 is rotatably accommodated in the mounting plate 8 by means of a pivot 15. An eccentric section 16 of the eccentric element 14 extends into a cross-slot 30 in the cross-step 11. Rotating the eccentric element 14, adjusts the fastening plate 7 longitudinally (i.e., horizontally in FIGS. 1 and 2) relative to the mounting plate 8, which is fixedly attached to the body of the furniture. The fastening plate 7 engages the longitudinal edges of the mounting plate 8 at edge flanges 17 and is thus guided in the longitudinal direction.

Upsetting the pivot 15 rotatably fixes the pivot 15 in the hole in the mounting plate 8. The cross-step 11 of the fastening plate 7 is thereby fixed in contact with the mounting plate 8 at this end of the fastening plate 7.

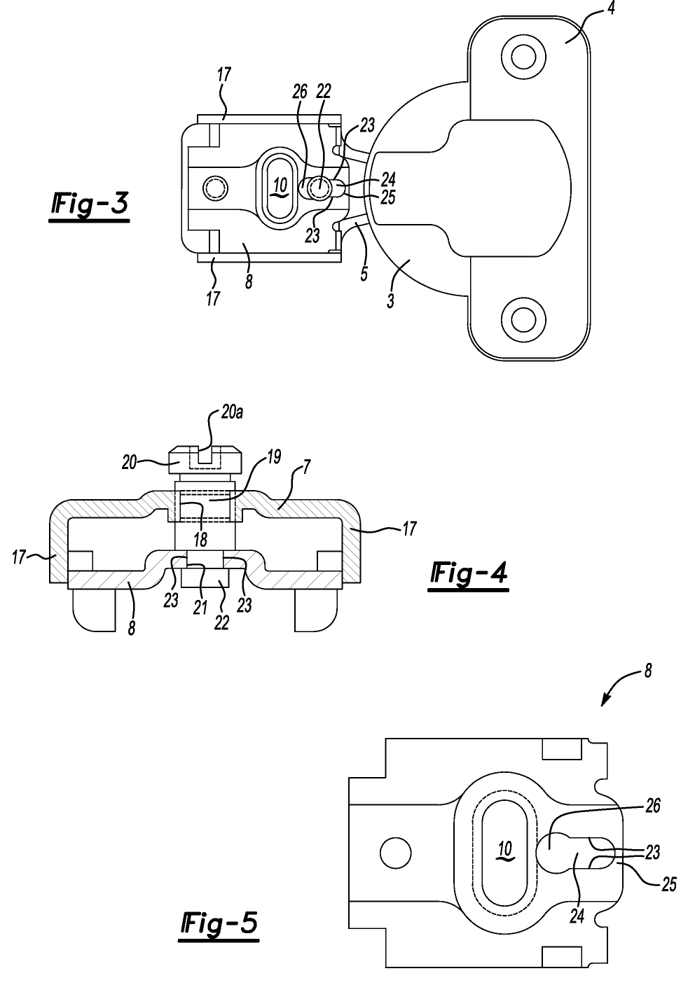

At the end of the fastening plate 7 toward the carrier arm 5, the fastening plate 7 accommodates a lateral adjustment screw 19 in a threaded hole 18 extending perpendicular to the plane of the plate, as shown in FIGS. 3 and 4. The screw 19 includes a screw head 20 having a slot 20a or a Philips-head accommodation.

The lateral adjustment screw 19 has a circumferential groove 21 on the end opposite the screw head 20. The circumferential grove 21 separates a second screw head 22 from other portions of the screw 19.

The circumferential groove 21 behind the screw head 22 accommodates the two edges 23 of the longitudinal slot 24 of the mounting plate 8. As shown in FIG. 5, the longitudinal slot 24 is closed at the end toward the carrier arm 5 by a stop 25 and includes an enlargement 26 on the other end.

The width of the slot between the two edges 23 is sized such that the neck of the screw head 22 formed by circumferential groove 21 fits between the longitudinal edges, while the screw head 22 extends past the two slot edges 23. During longitudinal adjustment of the fastening plate 7, the lateral adjustment screws 19 slides along the keyhole-shaped longitudinal slot 24.

The enlargement 26 at the end of the longitudinal slot 24 is sized to permit insertion of the screw head 22 during assembly.

By rotating the lateral adjustment screw 19, the carrier-arm end of the fastening plate 7 pivots relative to the mounting plate 8, while the other end, the end away from the carrier arm 5, maintains its position because the cross-step 11 is held in position on the mounting plate 8 by the eccentric element 14.

This pivoting motion of the mounting plate 7 as a result of the rotation of the lateral adjustment screw 19 also causes pivoting of the carrier arm 5. Through the linkage formed by the hinge pin 6, the door rabbet element 3 moves the furniture door 1 sideways in the front plane of the piece of furniture.

The longitudinal adjustment provision 12 adjusts the fastening plate 7, the carrier arm 5, and the door rabbet element 3 so that the distance between the closed furniture door 3 and the front-frame 2 can be adjusted.

When an overload breaks or loosens the connection between the fastening plate 7 and the mounting plate 7, the lateral adjustment screw 19 slides in the longitudinal slot 24 toward the carrier arm 5 only as far as the narrow end of the longitudinal slot 24. The lateral adjustment screw 19 maintains this position so that the door rabbet element 3 disposed on the carrier arm 5 does not immediately and completely separate from the mounting plate 7 under load. Instead, the lateral adjustment screw 19, which is screwed into the fastening plate 7, remains within the longitudinal slot 24 of the mounting plate 7. The lateral adjustment screw 19 only separates when the loading becomes so great that the lateral adjustment screw 19, the material surrounding the longitudinal slot 24, or both are deformed and destroyed. Such a result assumes an increasing load.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

I claim:

1. A furniture door hinge, comprising:
a carrier arm having a first arm end and a second arm end;
a door rabbet element rotatably fastened to said first arm end;
a fastening plate disposed on said second arm end, said fastening plate formed with said carrier arm and having a threaded hole near said carrier arm for receiving a lateral adjustment screw; and
a mounting plate attachable to the body of a piece of furniture, said second arm end longitudinally and laterally adjustably connected to said mounting plate, said fastening plate longitudinally guided across said mounting plate,
wherein said lateral adjustment screw accommodates at least one edge of a longitudinal slot in said mounting plate within a circumferential groove, said longitudinal slot closed near said carrier arm and enlarged away from said carrier arm to receive said screw head.

2. A furniture door hinge, comprising:
a carrier arm having a first arm end and a second arm end;
a door rabbet element rotatably fastened to said first arm end;
a lateral adjustment screw having a circumferential groove;
a fastening plate disposed on said second arm end, having a threaded hole near said carrier arm for receiving said lateral adjustment screw; and
a mounting plate attachable to the body of a piece of furniture and having a longitudinal slot, wherein said lateral adjustment screw accommodates at least one edge of said longitudinal slot in said mounting plate within said circumferential groove, and said longitudinal slot is closed near said carrier arm and enlarged away from said carrier arm to receive an enlarged end said screw.

3. The furniture door hinge of claim 2, wherein said fastening plate is formed with said carrier arm.

4. The furniture door hinge of claim 2, wherein said second arm end is longitudinally and laterally adjustably connected to said mounting plate.

5. The furniture door hinge of claim 2, wherein said fastening plate is longitudinally guided across said mounting plate.

6. The furniture door hinge of claim 2, wherein said door rabbet element is an insert cup.
